(19) United States
(12) Patent Application Publication
(10) Pub. No.: US 2025/0219409 A1
(43) Pub. Date: Jul. 3, 2025

(54) Energy Storage Synchronous Coordinated Management Method and System Based on Virtual Synchronization Technology

(71) Applicant: Hainan Power Grid Co., Ltd., Haikou (CN)

(72) Inventors: Zhongzhong LI, Haikou (CN); Lihong MA, Haikou (CN); Sifan LI, Haikou (CN); Changjun ZHANG, Haikou (CN); Hang ZHOU, Haikou (CN); Jianzhao CUI, Haikou (CN); Donghai LI, Haikou (CN); Dan QIN, Haikou (CN)

(21) Appl. No.: 19/013,544

(22) Filed: Jan. 8, 2025

Related U.S. Application Data
(63) Continuation of application No. PCT/CN2024/104638, filed on Jul. 10, 2024.

(30) Foreign Application Priority Data
Dec. 27, 2023 (CN) 2023118215806

(51) Int. Cl. H02J 3/00; G05B 13/02; H02J 3/16; H02J 3/38; H02J 7/00; H02J 13/00

(52) U.S. Cl. CPC H02J 3/00125; G05B 13/027; H02J 3/16; H02J 3/38; H02J 7/00712; H02J 13/00002; H02J 2203/20

(57) ABSTRACT

The present invention provides an energy storage synchronous coordinated management method and system based on virtual synchronization technology. The method comprises: selecting an appropriate energy storage device according to the requirements of a power grid and collecting related parameters; building a dynamic model of a virtual rotor, and setting rotational inertia of the rotor and torque parameters; building an adaptation layer; configuring a line monitoring apparatus, carrying out a safety operation when the fault occurs in the adaptation layer, or carrying out dynamic control and predictive planning in the absence of faults. The present invention utilizes intelligence to reduce reliance on experience, and enables dynamic optimization to improve the automation level of energy storage control.

### CROSS-REFERENCE TO RELATED APPLICATIONS

The present application claims priority to Chinese Patent Application No. 2023118215806, filed on Dec. 27, 2023, the entire disclosure of which is incorporated herein by reference.

### TECHNICAL FIELD

The present invention relates to the field of energy storage management technology, in particular to an energy storage synchronous coordinated management method and system based on virtual synchronization technology.

### BACKGROUND

As the proportion of new energy continually increases, the power grid is facing the challenges of increased volatility and uncertainty, which require energy storage technology to participate in peak regulation and valley filling of the power grid to achieve load balance. Meanwhile, the operation of the power grid also faces the threat of faults and accidents, which require an energy storage system to have emergency support capability for faults. Therefore, how to achieve coordinated joint control between the power grid and energy storage resources to improve the safety and stability of the power grid is a key technical challenge for the development of current power systems. Current power grid systems cannot coordinate energy storage resources or make emergency support response to faults.

Research on energy storage technology and coordinated control technology for the power grid is of great significance for promoting the high proportion of consumption of clean energy, ensuring the safe and efficient operation of the power grid, and achieving energy structure optimization.

### SUMMARY

In view of the above existing technologies, the objective of the present invention is to provide an energy storage synchronous coordinated management method and system based on virtual synchronization technology, which achieve predictive control on the state of a system and dynamic optimization scheduling of resources.

To achieve the above objective, the technical solution provided in a first aspect of the present invention is as follows:

An energy storage synchronous coordinated management method based on virtual synchronization technology includes the following steps:
S1. collecting parameters of an energy storage device;
S2. building a dynamic model of a virtual rotor according to the parameters of the energy storage device, and setting rotational inertia of the rotor and torque parameters;
S3. building an adaptation layer to achieve interaction between the virtual rotor and the physical energy storage device;
S4. configuring a line monitoring apparatus in a power grid, collecting real-time data of the energy storage device, detecting in real time whether a fault occurs, and carrying out a safety operation when the fault occurs in the adaptation layer, or carrying out dynamic control and predictive planning in the absence of faults, to solve the problem of uneven resource allocation; and
S5. Determine, by the adaptation layer, whether the real-time data of power grid nodes and the energy storage device are normal, and if so, save logs and end, otherwise re-check and set.

Preferably, S1 specifically includes:
obtaining a technical manual of the selected device and collecting precise parameters of the device, the precise parameters including efficiency, response time, cycle number, temperature, energy storage capacity, charge and discharge power curves, and a conversion efficiency curve; and
carrying out charge and discharge tests on the actual device to obtain working characteristic data, calibrating parameters in the manual, and summarizing and organizing all technical parameters obtained from the manual and the tests as basic data for subsequent modeling.

Preferably, S2 specifically includes:
obtaining the rotational inertia J of the rotor from a device parameter table in kg·m², computed by the following equation:

J=∫r²dm,
where r represents a distance between a mass element and a rotating shaft, and dm represents the mass element;
the building a dynamic model of a virtual rotor comprises:

defining a state variable: selecting an angular velocity ω of the rotor as a first state sub variable, denoted as x1; selecting an angular acceleration α of the rotor as a second state sub variable, denoted as x2, wherein the state variable is represented as:

$$x = [ x 1 ; x 2 ] = [ ω ; α ] ,$$

according to the Newton's second law, a kinetic equation of the rotor is:

$$J * a = T - Bw ,$$

where J represents the rotational inertia of the rotor, B represents a damping coefficient, and T represents a torque;
carrying out Laplace transform according to the kinetic equation of the rotor, to obtain a state equation:

$$x 1 = \frac{( T - B * x 1 - J * x 2 )}{J} ,$$

exporting an output equation and selecting the angular velocity ω of the rotor, namely, the first state sub variable x1 as an output variable y, wherein the output equation is represented as:

$$y = C * x = [ \begin{matrix}1 & 0 ] * [ x 1 ; x 2 ] = x 1 ,\end{matrix}$$

organizing the above equations into a state space equation:

$$x = [ 01 ; \frac{F}{J} - \frac{1}{J} ] * x + [ 0 ; \frac{1}{J} ] * {T}_{y} = [ \begin{matrix}1 & 0\end{matrix} ] * x$$

where

$$A = [ 01 ; - \frac{F}{J} - \frac{1}{J} ]$$

represents a state matrix,

$$F = [ 0 ; \frac{1}{J} ]$$

represents an input matrix, and C=[1 0] represents an output matrix;
carrying out model simulation on the state space equation to create two integration modules in Matlab/Simulink, integrating the state equation to obtain the first state sub variable x1 and the second state sub variable x2, then creating a gain module to compute the state matrix A and the input matrix F, finally creating an output module to compute the output matrix C and obtain the output variable y, and connecting the above modules to form a Simulink model of a state space model;
creating a standard test signal module, selecting step, direct flow, and sine as torque input signals, connecting the standard test signal module to an input end of the state space model, observing response of the first state sub variable x1 in a Scope module, namely, the angular velocity ω of the rotor, observing the shape, rising time, and resting error of a response curve, and finally adjusting the damping coefficient B and the rotational inertia J of the rotor in the state matrix A, to ensure that the shape and dynamic characteristics of the response curve gradually approach to those of an actual system; and
adjusting the damping coefficient B and the rotational inertia J of the rotor in the state matrix A, to ensure that the shape and dynamic characteristics of the response curve gradually approach to those of an actual system.

Preferably, S3 specifically includes:
receiving, by the adaptation layer, an output control signal of the virtual rotor, building, by the adaptation layer, a mapping relationship between speed w and reference power Pref through neural network training, and converting the output control signal into a physical energy storage recognition executable control instruction, as follows:

defining a neural network structure: setting 1 node in an input layer to represent the reference power Pref; setting 1 node in an output layer to represent the speed w; setting m nodes in a hidden layer;
assuming that a parameter from the input layer to the hidden layer is a weight matrix W1 and a parameter from the hidden layer to the output layer is a weight matrix W2, setting a neural network predicted speed w as follows:

$$w = f ( Pref ) = {W}_{2} g ( {W}_{1} Pref + b 1 ) + b 2 ,$$

where g represents an activation function of the hidden layer, b1 represents a bias vector of the hidden layer, b2 represents a bias vector of the output layer, ƒ represents a mapping relationship function, Pref represents input power, W1 represents a weight matrix connecting the Pref and the hidden layer, and W2 represents a weight matrix connecting the hidden layer and the output layer;
collecting training data {Pref, w}, computing a mean square error between the network predicted speed w and an actual speed w as a loss function L, optimizing W1, W2, b1, and b2 through an error back-propagation algorithm to minimize the loss L, repeatedly training the network to gradually reduce the loss function and obtain a final mapping model, and predicting a corresponding speed w using the model ƒ(Pref) on the new Pref; and
receiving, by the adaptation layer, a real-time speed w of the rotor in real-time control, computing the corresponding Pref by the mapping relationship function ƒ, converting the Pref value into a control instruction of a standard communication protocol, and sending the control instruction to a control system of the energy storage device, wherein the adaptation layer is connected to the control system of the device by a reliable industrial communication link to ensure that the instruction can arrive on time; after a local controller of the device receives the instruction, activating a power control closed loop to driving components such as an inverter, to ensure that the real-time power P of the device tracks the reference value Pref.

Preferably, S3 further includes building constraints between the adaptation layer and the energy storage device, where the constraints between the adaptation layer and the energy storage device specifically include:
if the speed output by the virtual rotor fluctuates abnormally, the adaptation layer needs to be configured with a low-pass filter to smooth the speed signal, so as to avoid issuing a control instruction for severe fluctuations to the energy storage device;
if there is hysteresis or inertia effect inside the energy storage device, the adaptation layer needs to be added with historical states in the neural network model, to improve the adaptability to dynamic hysteresis characteristics;
if the actual power tracking performance of the device is poor, the adaptation layer needs to appropriately expand a tolerance between the control instruction and an actual power value, to avoid the impact of frequent switching on the device; and
if packet loss or delay occurs in an industrial communication network, the adaptation layer activates local predictive model compensation control when detecting a fault to ensure system stability.

Preferably, the safety operation in S4 specifically includes:
configuring line detection apparatuses at key nodes of the power grid, and installing current transformers to detect line current in real time on lines of the power grid; when the current exceeds a threshold, triggering an alarm; installing voltage transformers at the nodes to monitor voltage amplitude and phase in real time and determining voltage faults;
collecting voltage data of each node during normal operation of the power grid, computing a maximum value Uₘₐₓ, a minimum value Uₘᵢₙ, and an average value U_{avg} of the voltage;
determining an ultra-high voltage threshold: U_{high}=Uₘₐₓ+a %*(Uₘₐₓ−U_{avg});
determining an ultra-low voltage threshold: U_{low}=Uₘᵢₙ−β%*(U_{avg}−Uₘᵢₙ);
where a and β represent empirical values ranging from 0 to 100;
collecting statistics on average current I_{avg} and maximum current Iₘₐₓ of each line during normal power supply,
determining an overload alarm point: Iₒᵥₑᵣ=k1*Iₘₐₓ,
determining an overcurrent fault point: I_{fault}=k2*Iₘₐₓ,
where k1 represents a normal load rate of a reference line, and
k2 represents 120% to 130% of rated current of the reference line;
when detecting, if the detected voltage is greater than U_{high} and lasts for more than t1 seconds, determining an ultra-high voltage fault; if the detected voltage is less than U_{low} and lasts for t2 seconds, determining an ultra-low voltage fault; if the current is greater than Iₒᵥₑᵣ and lasts for more than t3 seconds, giving an overload alarm; if the current exceeds I_{fault} and lasts for t4 seconds, determining an overcurrent fault;
where t1 is 2 to 3 seconds, t2 is 1 to 2 seconds, t3 is 10 to 20 seconds, and t4 is 0.5 to 1 second;
if the adaptation layer detects the ultra-high voltage fault, sending a boost charge instruction to the energy storage device to increase direct current bus voltage, sending a reactive power compensation instruction to a distribution network, and sending an excitation current decreasing instruction to an LCU of a water turbine unit to help decrease grid side voltage;
if the adaptation layer detects the ultra-low voltage fault, sending a buck discharge instruction to the energy storage device to help maintain bus voltage, sending a reactive power compensation instruction to the distribution network, and sending an excitation current increasing instruction to the LCU of the water turbine unit to help increase grid side voltage;
if the adaptation layer detects the overload fault, immediately sending a maximum discharge power instruction to the energy storage device to shunt and reduce a load, and sending a load cutting instruction to a load side to reduce overload;
if the adaptation layer detects the overcurrent fault, immediately sending a trip instruction to a circuit breaker to cut off a faulty segment, and sending an emergency stop instruction to the energy storage device to avoid affecting the device;
where the overload fault indicates that the device bears current or load exceeding its rated current or power in a short time, resulting in overheating or damage of the device or other safety problems, called a partial device fault; the overcurrent fault indicates a phenomenon that the instantaneous current in the circuit exceeds the designed rated current of the device or circuit;
if no faults are found in real-time monitoring, collecting all real-time data of the energy storage device and sending the data to the adaptation layer.

Preferably, the dynamic control and predictive planning in S4 include determining a balance or not and sending, by the adaptation layer, a balance instruction for dynamic coordination, the determining a balance or not includes the following specific steps:
computing an average SOC value SOC_{avg} of all devices and collecting statistics on the quantity of devices currently with excessively high or low SOC;
determining whether there is SOC imbalance in the system;
checking whether a balance of power and electric quantity is established; and
setting a tolerance control deviation range;
wherein the sending, by the adaptation layer, a balance instruction for dynamic coordination comprises sending a discharge control instruction to the devices with excessively high SOC and sending a charge instruction to the devices with excessively low SOC; adjusting charge and discharge power Pi of each device using closed-loop control, and repeatedly computing and sending the control instructions at certain time intervals for dynamic coordination until the SOC of each device restores to balance.

Preferably,
the collecting statistics on the quantity of devices currently with excessively high or low SOC includes:
computing the average SOC value SOC_{avg} of all the devices and setting allowable up and down fluctuating ranges of SOC; if the SOC of a device is greater than the SOC_{avg} by the allowable up fluctuating range, determining that the SOC of the device is excessively high; if the SOC of a device is less than the SOC_{avg} by the allowable down fluctuating range, determining that the SOC of the device is excessively low; setting the quantity of devices with excessively high SOC as n_{high}, and setting the quantity of devices with excessively low SOC as n_{low};
wherein the determining whether there is SOC imbalance in the system comprises:
setting a tolerance percentage P_{allow} for allowed SOC imbalance, and computing an upper limit of the quantity of devices with allowed SOC imbalance as follows:

$${n}_{threshold} = {n}_{total} * {P}_{allow} ;$$

if n_{high}>n_{threshold} Of n_{low}>n_{threshold}, determining that there is SOC imbalance in the system;
wherein the checking whether a balance of power and electric quantity is established comprises:
determining capacity Ci and current SOCi, and for the device with excessively high SOC, computing its electric quantity that exceeds an average value:

$$Δ Qi = Ci \times ( SOCi - SOCavg ) ;$$

for the device with excessively low SOC, computing its electric quantity that needs to be replenished:

$$Δ Qi = Ci \times ( SOCavg - SOCi ) ;$$

summarizing a total discharge capacity ΔQ_discharge of all the devices with excessively high SOC and a total charge capacity ΔQ_charge of the devices with excessively low SOC, and mapping the ΔQi to the corresponding charge and discharge power Pi:

$$Pi = \frac{Δ Qi}{Δ t}$$

where Δt represents a step size; limiting the amplitude of the power Pi to not exceed the rated power of a single device;
checking whether the balance of power and electric quantity is established:

$$\sum Pi * Δ t = \sum Δ Qi ;$$

wherein the setting a tolerance control deviation range comprises:
testing response time Tᵣₑₛₚₒₙₛₑ of different models of energy storage devices executing the standard power control instruction, measuring power control precision error ε_{precision} of the devices under different SOC and temperature conditions, and setting a control cycle T_{control};
computing a response time tolerance range:

$$δ {t}_{resaponse} = {T}_{response} - {T}_{control} ;$$

computing a precision tolerance range:

$$δ {P}_{precision} = 2 * {ε}_{precision} ;$$

comprehensively determining a total tolerance deviation range for power control:

$$Δ {P}_{tol} = δ {P}_{response} + δ {P}_{precision} ;$$

if sending a control instruction, considering a margin of ΔPₜₒₗ as follows:
P_{cmd}=P_{ideal}±ΔPₜₒₗ, wherein P_{ideal} represents target power;
if detecting feedback, keeping the actual power of the device within upper and lower limits:
P_{ideal}−ΔPₜₒₗ_≤Pᵣₑₐₗ_≤P_{ideal}+ΔPₜₒₗ, wherein Pᵣₑₐₗ represents real power.

A second aspect of the present invention provides an energy storage synchronous coordinated management system based on virtual synchronization technology, including:
a device parameter collection module, configured to collect parameters of an energy storage device;
a model building module, configured to build a dynamic model of a virtual rotor according to the parameters of the energy storage device, and set rotational inertia of the rotor and torque parameters;
an adaptation layer building module, configured to build an adaptation layer to achieve interaction between the virtual rotor and the physical energy storage device;
a line detection apparatus, configured in a power grid to collect real-time data of the energy storage device, detect in real time whether a fault occurs, and carry out a safety operation when the fault occurs in the adaptation layer, or carry out dynamic control and predictive planning in the absence of faults, to solve the problem of uneven resource allocation; and
the adaptation layer, configured to determine whether the real-time data of power grid nodes and the energy storage device are normal, and if so, save logs and end, otherwise re-check and set.

The beneficial effects of the present invention are as follows:

The present invention provides an energy storage synchronous coordinated management method and system based on virtual synchronization technology, where a line monitoring apparatus is configured to monitor in real time whether a fault occurs in a power grid, which solves the problem of slow response to the fault of the power grid; by quickly recognizing fault points, emergency measures can be taken in a timely manner, thereby greatly improving the safety and reliability of the power grid; an adaptation layer is built for safety operation during the fault of the power grid and dynamic control at ordinary times. The design of the adaptation layer greatly enhances the coordination ability between the power grid and an energy storage system. On the one hand, the adaptation layer can actively participate in adjustment during the fault of the power grid, thereby improving the self-recovery capability of the power grid; on the other hand, the adaptation layer can optimize and schedule the energy storage system to improve resource allocation efficiency; the cooperation of a virtual rotor model and the adaptation layer achieves state monitoring and predictive control on the energy storage device. Therefore, the present invention better balances the needs of system security, economy, and other aspects, provides effective technical means for the coordinated control of the power grid and energy storage, is conducive to improving the flexibility and coordination of the system, and achieves intelligent upgrade of the power system. The present invention further uses intelligent means to replace traditional empirical control, which not only reduces experience dependence but also enables dynamic optimization to greatly improve the automation level of energy storage control.

### BRIEF DESCRIPTION OF DRAWINGS

To describe the technical solutions in embodiments of the present invention more clearly, the following briefly describes the accompanying drawings required for describing the embodiments. Apparently, the accompanying drawings in the following descriptions show merely the preferred embodiments of the present invention, and those of ordinary skill in the art may derive other drawings from these accompanying drawings without creative efforts.

FIG. 1 is a flowchart of an energy storage synchronous coordinated management method based on virtual synchronization technology provided in an embodiment of the present invention.

### DETAILED DESCRIPTION OF THE EMBODIMENTS

The principles and features of the present invention are described below in conjunction with the accompanying drawings. The listed embodiments are only for explaining the present invention and are not intended to limit the scope of the present invention.

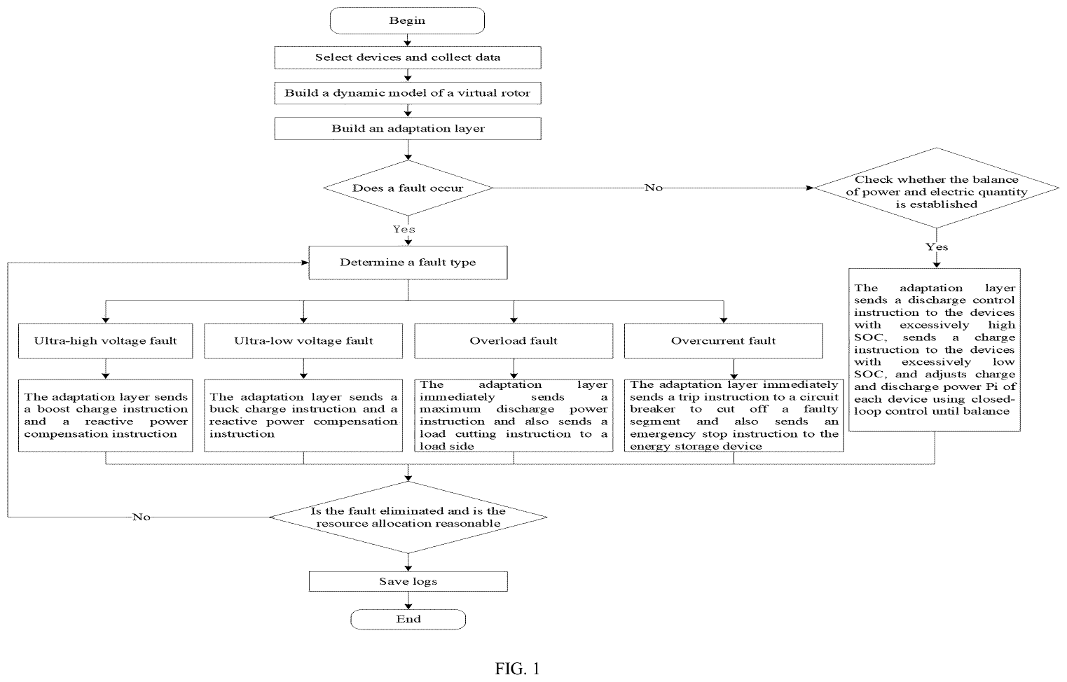

With reference to FIG. 1, this embodiment provides an energy storage synchronous coordinated management method based on virtual synchronization technology, including the following steps:
S1. Collect parameters of an energy storage device.
S2. Build a dynamic model of a virtual rotor according to the parameters of the energy storage device, and set rotational inertia of the rotor and torque parameters.
S3. Build an adaptation layer to achieve interaction between the virtual rotor and the physical energy storage device.
S4. Configure a line monitoring apparatus in a power grid, collect real-time data of the energy storage device, detect in real time whether a fault occurs, and carry out a safety operation when the fault occurs in the adaptation layer, or carry out dynamic control and predictive planning in the absence of faults, to solve the problem of uneven resource allocation.
S5. Determine, by the adaptation layer, whether the real-time data of power grid nodes and the energy storage device are normal, and if so, save logs and end, otherwise re-check and set.

S1 specifically includes:
obtaining a technical manual of the selected device and collecting precise parameters of the device, the precise parameters including efficiency, response time, cycle number, temperature, energy storage capacity, charge and discharge power curves, and a conversion efficiency curve; and
carrying out charge and discharge tests on the actual device to obtain working characteristic data, calibrating parameters in the manual, and summarizing and organizing all technical parameters obtained from the manual and the tests as basic data for subsequent modeling.

S2 specifically includes:
obtaining the rotational inertia J of the rotor from a device parameter table in kg·m², where the rotational inertia is related to the shape, dimension, material, and speed of the rotor, and is calculated by the following equation:

$$J = \int {r}^{2} dm ,$$

where r represents a distance between a mass element and a rotating shaft, and dm represents the mass element;
obtaining a torque parameter KT of a rotating shaft, which represents a torque magnitude of the rotating shaft at given current, in N·m/A, where the parameter reflects a relationship between electromagnetic torque of a motor and current; obtaining a torque parameter KM of the motor, which represents torque output of the motor at given voltage/current, in N·m/V or N·m/A, where the parameter can be determined from a speed-torque curve of the motor;
describing rotor motion using second-order inertial elements, and building a state space equation with an angular velocity of the rotor as a state variable.
the building a dynamic model of a virtual rotor comprises:
defining a state variable: selecting an angular velocity ω of the rotor as a first state sub variable, denoted as x1; selecting an angular acceleration α of the rotor as a second state sub variable, denoted as x2, wherein the state variable is represented as:

$$x = [ x 1 ; x 2 ] = [ ω ; α ] ,$$

according to the Newton's second law, a kinetic equation of the rotor is:

$$J * a = T - Bw ,$$

where J represents the rotational inertia of the rotor, B represents a damping coefficient, and T represents a torque;
carrying out Laplace transform according to the kinetic equation of the rotor, to obtain a state equation:

$$x 1 = \frac{( T - B * x 1 - J * x 2 )}{J} ,$$

exporting an output equation and selecting the angular velocity ω of the rotor, namely, the first state sub variable x1 as an output variable y, wherein the output equation is represented as:

$$y = C * x = [ 10 ] * [ x 1 ; x 2 ] = x 1 ,$$

organizing the above equations into a state space equation:

$$x = [ 01 ; \frac{F}{J} - \frac{1}{J} ] * x [ 0 ; \frac{1}{J} ] * {T}_{y} = [ 10 ] * x$$

where

$$A = [ 01 ; - \frac{F}{J} - \frac{1}{J} ]$$

represents a state matrix,

$$F = [ 0 ; \frac{1}{J} ]$$

represents an input matrix, and C=[1 0] represents an output matrix;
carrying out model simulation on the state space equation to create two integration modules in Matlab/Simulink, integrating the state equation to obtain the first state sub variable x1 and the second state sub variable x2, then creating a gain module to compute the state matrix A and the input matrix F, finally creating an output module to compute the output matrix C and obtain the output variable y, and connecting the above modules to form a Simulink model of a state space model;
creating a standard test signal module, selecting step, direct flow, and sine as torque input signals, connecting the standard test signal module to an input end of the state space model, observing response of the first state sub variable x1 in a Scope module, namely, the angular velocity ω of the rotor, observing the shape, rising time, and resting error of a response curve, and finally adjusting the damping coefficient B and the rotational inertia J of the rotor in the state matrix A, to ensure that the shape and dynamic characteristics of the response curve gradually approach to those of an actual system; and
adjusting the damping coefficient B and the rotational inertia J of the rotor in the state matrix A, to ensure that the shape and dynamic characteristics of the response curve gradually approach to those of an actual system.

S3 specifically includes:

The virtual rotor is a mathematical model based on dynamic modeling, and cannot directly interact with the physical energy storage device, so the adaptation layer is built to achieve information exchange and a control interface between the two.

The adaptation layer is configured to receive an output control signal of the virtual rotor, build a mapping relationship between speed w and reference power Pref through neural network training, and convert the output control signal into a physical energy storage recognition executable control instruction, as follows:
defining a neural network structure: setting 1 node in an input layer to represent the reference power Pref; setting 1 node in an output layer to represent the speed w; setting m nodes in a hidden layer;
assuming that a parameter from the input layer to the hidden layer is a weight matrix W1 and a parameter from the hidden layer to the output layer is a weight matrix W2, setting a neural network predicted speed w as follows:

$$w = f ( Pref ) = {W}_{2} g ( {W}_{1} Pref + b 1 ) + b 2 ,$$

where g represents an activation function of the hidden layer, b1 represents a bias vector of the hidden layer, b2 represents a bias vector of the output layer, ƒ represents a mapping relationship function, Pref represents input power, W1 represents a weight matrix connecting the Pref and the hidden layer, and W2 represents a weight matrix connecting the hidden layer and the output layer;
collecting training data {Pref, w}, computing a mean square error between the network predicted speed w and an actual speed w as a loss function L, optimizing W1, W2, b1, and b2 through an error back-propagation algorithm to minimize the loss L, repeatedly training the network to gradually reduce the loss function and obtain a final mapping model, and predicting a corresponding speed w using the model ƒ(Pref) on the new Pref, and receiving, by the adaptation layer, a real-time speed w of the rotor
in real-time control, computing the corresponding Pref by the mapping relationship function ƒ, converting the Pref value into a control instruction of a standard communication protocol, and sending the control instruction to a control system of the energy storage device, wherein the adaptation layer is connected to the control system of the device by a reliable industrial communication link to ensure that the instruction can arrive on time; after a local controller of the device receives the instruction, activating a power control closed loop to driving components such as an inverter, to ensure that the real-time power P of the device tracks the reference value Pref.

S3 further includes building constraints between the adaptation layer and the energy storage device, where the constraints between the adaptation layer and the energy storage device specifically include:
if the speed output by the virtual rotor fluctuates abnormally, the adaptation layer needs to be configured with a low-pass filter to smooth the speed signal, so as to avoid issuing a control instruction for severe fluctuations to the energy storage device;
if there is hysteresis or inertia effect inside the energy storage device, the adaptation layer needs to be added with historical states in the neural network model, to improve the adaptability to dynamic hysteresis characteristics;
if the actual power tracking performance of the device is poor, the adaptation layer needs to appropriately expand a tolerance between the control instruction and an actual power value, to avoid the impact of frequent switching on the device; and
if packet loss or delay occurs in an industrial communication network, the adaptation layer activates local predictive model compensation control when detecting a fault to ensure system stability.

The amplitude of fluctuation is compared with an absolute value of the speed; if the amplitude of fluctuation exceeds 10% of the speed, the fluctuation is determined as abnormal fluctuation; if the device frequently switches from a high power mode to a low power mode (or vice versa) within a short time, it indicates that the device control system cannot stably maintain a specific power level, resulting in poor power tracking performance of the actual device;

Further, the adaptation layer needs to be configured with a physical interface, specifically an existing standard industrial engineering interface connected to a local control system, and be configured with a QoS priority using DENET technology to isolate control data traffic, so as to ensure determined real-time communication;

It should be noted that the adaptation layer is also configured to collect real-time state data of the physical energy storage device, such as current power, voltage and current parameters, and feed the data back to the virtual rotor model to complete state update.

The safety operation in S4 specifically includes:
configuring line detection apparatuses at key nodes of the power grid, such as substations and intersections of a ring network, and installing current transformers to detect line current in real time on lines of the power grid; when the current exceeds a threshold, triggering an alarm; installing voltage transformers at the nodes to monitor voltage amplitude and phase in real time and determining voltage faults;
collecting voltage data of each node during normal operation of the power grid, computing a maximum value Uₘₐₓ, a minimum value Uₘᵢₙ, and an average value U_{avg} of the voltage;
determining an ultra-high voltage threshold: U_{high}=Uₘₐₓ+a %*(Uₘₐₓ−U_{avg});
determining an ultra-low voltage threshold: U_{low}=Uₘᵢₙ−β%*(U_{avg}−Uₘᵢₙ);
where a and β represent empirical values ranging from 0 to 100, and the general empirical values are 10% according to current project requirements;
collecting statistics on average current I_{avg} and maximum current Iₘₐₓ of each line during normal power supply,
determining an overload alarm point: Iₒᵥₑᵣ=k1*Iₘₐₓ,
determining an overcurrent fault point: I_{fault}=k2*Iₘₐₓ,
where k1 represents a normal load rate of a reference line, reserved with a certain margin, empirically 80% to 85% of rated current; considering load changes in different seasons, sufficient margin is given to adapt to load increase;
where K2 represents 120% to 130% of the rated current of the reference line; the values of k1 and k2 need to be flexibly adjusted according to neutral grounding methods of the transformers and device configuration;
when detecting, if the detected voltage is greater than U_{high} and lasts for more than t1 seconds, determining an ultra-high voltage fault; if the detected voltage is less than U_{low} and lasts for t2 seconds, determining an ultra-low voltage fault; if the current is greater than Iₒᵥₑᵣ and lasts for more than t3 seconds, giving an overload alarm; if the current exceeds I_{fault} and lasts for t4 seconds, determining an overcurrent fault;
where t1 is 2 to 3 seconds, t2 is 1 to 2 seconds, t3 is 10 to 20 seconds, and t4 is 0.5 to 1 second; ultra-high voltage and ultra-low voltage have a great impact on the system, so the determination time limit is slightly short; the system can bear overload for certain time, so the alarm time limit is relatively long; the overcurrent fault has a significant impact on the system and requires prompt determination and response, so its time limit is short;
if the adaptation layer detects the ultra-high voltage fault, sending a boost charge instruction to the energy storage device to increase direct current bus voltage, sending a reactive power compensation instruction to a distribution network, and sending an excitation current decreasing instruction to an LCU of a water turbine unit to increase related instruction control on the excitation control unit LCU of the water turbine unit and help decrease grid side voltage;
if the adaptation layer detects the ultra-low voltage fault, sending a buck discharge instruction to the energy storage device to help maintain bus voltage, sending a reactive power compensation instruction to the distribution network, and sending an excitation current increasing instruction to the LCU of the water turbine unit to increase related instruction control on the excitation control unit LCU of the water turbine unit and help increase grid side voltage;
if the adaptation layer detects the overload fault, immediately sending a maximum discharge power instruction to the energy storage device to shunt and reduce a load, and sending a load cutting instruction to a load side to reduce overload;
if the adaptation layer detects the overcurrent fault, immediately sending a trip instruction to a circuit breaker to cut off a faulty segment, and sending an emergency stop instruction to the energy storage device to avoid affecting the device;
where the overload fault indicates that the device bears current or load exceeding its rated current or power in a short time, resulting in overheating or damage of the device or other safety problems, called a partial device fault; the overcurrent fault indicates a phenomenon that the instantaneous current in the circuit exceeds the designed rated current of the device or circuit;
if no faults are found in real-time monitoring, collecting all real-time data of the energy storage device, including SOC margin, voltage, current, temperature parameters, etc., and sending the data to the adaptation layer.

The dynamic control and predictive planning in S4 include determining a balance or not and sending, by the adaptation layer, a balance instruction for dynamic coordination,
the determining a balance or not includes the following specific steps:
computing an average SOC value SOC_{avg} of all devices and collecting statistics on the quantity of devices currently with excessively high or low SOC;
determining whether there is SOC imbalance in the system;
checking whether a balance of power and electric quantity is established; and
setting a tolerance control deviation range;
wherein the sending, by the adaptation layer, a balance instruction for dynamic coordination comprises sending a discharge control instruction to the devices with excessively high SOC and sending a charge instruction to the devices with excessively low SOC; adjusting charge and discharge power Pi of each device using closed-loop control, and repeatedly computing and sending the control instructions at certain time intervals for dynamic coordination until the SOC of each device restores to balance.
the collecting statistics on the quantity of devices currently with excessively high or low SOC includes:
computing the average SOC value SOC_{avg} of all the devices and setting allowable up and down fluctuating ranges of SOC, generally±5% SOC_{avg}; if the SOC of a device is greater than the SOC_{avg} by the allowable up fluctuating range, determining that the SOC of the device is excessively high; if the SOC of a device is less than the SOC_{avg} by the allowable down fluctuating range, determining that the SOC of the device is excessively low; setting the quantity of devices with excessively high SOC as n_{high}, and setting the quantity of devices with excessively low SOC as n_{low};
wherein the determining whether there is SOC imbalance in the system comprises:
setting a tolerance percentage P_{allow} for allowed SOC imbalance, and computing an upper limit of the quantity of devices with allowed SOC imbalance as follows:

$${n}_{threshold} = {n}_{total} * {P}_{allow} ;$$

if n_{high} n_{threshold} Of n_{low}>n_{threshold}, determining that there is SOC imbalance in the system;
where P_{allow} is set according to the capacity of a battery pack, and P_{allow} is set to 3% in the current embodiment.
wherein the checking whether a balance of power and electric quantity is established comprises:
determining capacity Ci and current SOCi, and for the device with excessively high SOC, computing its electric quantity that exceeds an average value:

$$Δ Qi = Ci \times ( SOCi - SOCavg ) ;$$

for the device with excessively low SOC, computing its electric quantity that needs to be replenished:

$$Δ Qi = Ci \times ( SOCavg - SOCi ) ;$$

summarizing a total discharge capacity ΔQ_discharge of all the devices with excessively high SOC and a total charge capacity ΔQ_charge of the devices with excessively low SOC, and mapping the ΔQi to the corresponding charge and discharge power Pi:

$$Pi = \frac{Δ Qi}{Δ t}$$

where Δt represents a step size; limiting the amplitude of the power Pi to not exceed the rated power of a single device;
checking whether the balance of power and electric quantity is established:

$$\sum Pi * Δ t = \sum Δ Qi ;$$

finely adjusting power allocation to achieve balance, converting the finally determined Pi into a speed control signal according to the speed-power mapping relationship, and considering the impact of communication delay on control, setting a timing relationship to compensate for the impact of network delay; considering the response time and precision error of different devices, setting the tolerance control deviation range.
wherein the setting a tolerance control deviation range comprises:
testing response time Tᵣₑₛₚₒₙₛₑ of different models of energy storage devices executing the standard power control instruction, measuring power control precision error E_{precision} of the devices under different SOC and temperature conditions, and setting a control cycle T control;
computing a response time tolerance range:

$$δ {t}_{response} = {T}_{response} - {T}_{control} ;$$

computing a precision tolerance range:

$$δ {P}_{precision} = 2 * {ε}_{precision} ;$$

comprehensively determining a total tolerance deviation range for power control:

$$Δ {P}_{tol} = δ {P}_{response} + δ {P}_{precision} ;$$

if sending a control instruction, considering a margin of ΔPₜₒₗ as follows:
P_{cmd}=P_{ideal}±ΔPₜₒₗ, wherein P_{ideal} represents target power;
if detecting feedback, keeping the actual power of the device within upper and lower limits:
P_{ideal}−ΔPₜₒₗ≤Pᵣₑₐₗ≤P_{ideal}+ΔPₜₒₗ, wherein Pᵣₑₐₗ represents real power.
When the control instruction is sent, considering that the margin of ΔP_tol is P_{cmd}=P_{ideal}±ΔPₜₒₗ, as long as the actual power of the device is within the upper and lower limits during feedback detection: P_{ideal}−ΔPₜₒₗ_≤Pᵣₑₐₗ_≤P_{ideal}+ΔPₜₒₗ, it is considered that the control is valid, thereby avoiding unnecessary fluctuation adjustment. The measurement tolerance range is regularly calibrated and on-line adaptive optimization is carried out.

Based on the same inventive concept as the aforementioned method embodiment, another embodiment of the present invention provides an energy storage synchronous coordinated management system based on virtual synchronization technology, including:
a device parameter collection module, configured to collect parameters of an energy storage device;
a model building module, configured to build a dynamic model of a virtual rotor according to the parameters of the energy storage device, and set rotational inertia of the rotor and torque parameters;
an adaptation layer building module, configured to build an adaptation layer to achieve interaction between the virtual rotor and the physical energy storage device;
a line detection apparatus, configured in a power grid to collect real-time data of the energy storage device, detect in real time whether a fault occurs, and carry out a safety operation when the fault occurs in the adaptation layer, or carry out dynamic control and predictive planning in the absence of faults, to solve the problem of uneven resource allocation; and
the adaptation layer, configured to determine whether the real-time data of power grid nodes and the energy storage device are normal, and if so, save logs and end, otherwise re-check and set.

The working principle and beneficial effects of the system embodiment are the same as those of the previous method embodiment, and will not be repeated here.

Another embodiment of the present invention further provides a computer device applicable to the energy storage synchronous coordinated management method based on virtual synchronization technology, including a memory and a processor, where the memory is configured to store computer executable instructions, and the processor is configured to execute the computer executable instructions to implementing the energy storage synchronous coordinated management method based on virtual synchronization technology provided in the above embodiments.

The computer device may be a terminal. The computer device includes a processor, a memory, a communication interface, a display, and an input apparatus connected by a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in a wired or wireless manner, where the wireless manner may be implemented by WIFI, an operator network, NFC (Near Field Communication) or other technologies. The display of the computer device may be a liquid crystal display or an electronic ink display. The input apparatus of the computer device may be a touch layer covering the display, or may be a button, a trackball, or a touchpad disposed on a housing of the computer device, or may be an external keyboard, an external touchpad, a mouse, or the like.

Another embodiment of the present invention further provides a storage medium, storing a computer program that, when executed by a processor, implements the energy storage synchronous coordinated management method based on virtual synchronization technology provided in the above embodiments.

In order to verify the beneficial effects of the present invention, scientific verification was carried out by economic benefit computations and simulation experiments.

To verify the functionality of this method, a three-dimensional simulation environment of a power station and an energy storage station was built, including a distributed photovoltaic station with a total installed capacity of 300 MW and a 100 MW/400 MWh energy storage station;

Line monitoring apparatuses were installed at an access point of the photovoltaic power station and an entrance substation of a distribution network, with the following device parameters:

TABLE 1
Parameter information of relevant devices

| Monitoring | | | | |
|---|---|---|---|---|
| apparatus | Model | Range | | Precision |
| Current transformer | XX-100 | 0-1000 | A | Level 0.2 |
| Voltage transformer | XX-35 | 0~40 | kV | Level 0.2 |

Upper and lower limit voltage alarm values and current overload and overcurrent alarm values were set.

During operation, the voltage measured at key nodes of the distribution network was 38.5 kV, which was less than the lower limit of 85% by 32 kV for more than 2 seconds. A line monitoring module determined an under-voltage fault. In response to the under-voltage fault, the line monitoring module detected the fault within 2.1 seconds and sent a signal to the adaptation layer within 50 milliseconds. An adaptation layer issued a discharge instruction to an energy storage management system within 1.2 seconds after receiving the fault signal, and an energy storage system was activated to supply power at the maximum power (80 MW) within 2.1 seconds to assist in restoring the voltage of the distribution network.

A SELECTION-500 server was used as an operating platform, a mapping relationship between speed and power was built by means of a neural network to accurately predict the output of the energy storage system, and the adaptation layer was built. Parameters of a virtual rotor model were determined by PSCAD simulation: rotational inertia J=8000 kg·m², torque constant KT=10N·m/A. The adaptation layer platform sent a coordination instruction every 5 minutes to optimize working points of four 100 MW/400 MWh lithium battery energy storage systems and maintain SOC balance. By experiments, the photovoltaic grid-connected capacity was significantly increased, the fault response time of the power grid was shortened by 58%, and the peak regulation quantity was increased by 35%.

Specifically, the comparison between the technical solution of the present invention and existing technologies is shown in Table 2:

TABLE 2
Comparison between the present invention and existing technologies

| | | Technical solution of the |
|---|---|---|
| Technical indicator | Existing technologies | present invention |
| Fault detection time | 5-10 seconds | <2 seconds |
| Fault positioning accuracy | Low, require manual analysis | High, automatic positioning |
| Fault response time | >10 seconds | <5 seconds |
| Energy storage scheduling | Experiential scheduling | Automatic optimization |
| strategy | | scheduling based on big data |
| | | and AI |
| Energy storage coordinated | No coordination system | Collaborative control with a |
| control | | virtual rotor model |
| Resource allocation | Static configuration | Dynamic optimization |
| optimization | | |
| Balance system security and | Difficult to balance | Balance monitoring and |
| economy | | intelligent scheduling |
| Technical reliability | Ordinary | Multi-loop redundant |
| | | monitoring, high reliability |
| Technical automation level | Partial automation | Intelligent decision-making |
| | | and control throughout the |
| | | entire process |
| Technical complexity | Relatively high | Concise and clear control |
| | | strategy |
| Difficulty level of technical | Relatively difficult | Flexible and applicable |
| promotion | | control framework |

It can be clearly seen from the table that the present invention has significant improvements and advantages over the existing technologies in terms of fault detection response time, precise positioning, coordinated control, resource optimization configuration, etc., has better overall performance than the existing technologies, and is easy to promote and apply.

Described above are the specific implementations of the present invention, but the protection scope of the present invention is not limited thereto. Any skilled person who is familiar with this art can readily conceive of variations or substitutions within the technical scope disclosed by the present invention, and these variations or substitutions shall fall within the protection scope of the present invention. The protection scope of the present invention shall be subject to the protection scope of the claims.

What is claimed is:

1. An energy storage synchronous coordinated management method based on virtual synchronization technology, comprising the following steps:
S1. collecting parameters of an energy storage device;
S2. building a dynamic model of a virtual rotor according to the parameters of the energy storage device, and setting rotational inertia of the rotor and torque parameters;
S3. building an adaptation layer to achieve interaction between the virtual rotor and the physical energy storage device;
S4. configuring a line monitoring apparatus in a power grid, collecting real-time data of the energy storage device, detecting in real time whether a fault occurs, and carrying out a safety operation when the fault occurs in the adaptation layer, or carrying out dynamic control and predictive planning in the absence of faults, to solve the problem of uneven resource allocation; and
S5. determining, by the adaptation layer, whether the real-time data of power grid nodes and the energy storage device are normal, and if so, saving logs and ending, otherwise re-checking and setting.

2. The energy storage synchronous coordinated management method based on virtual synchronization technology according to claim 1, wherein S1 specifically comprises:
obtaining a technical manual of the selected device and collecting precise parameters of the device, the precise parameters comprising efficiency, response time, cycle number, temperature, energy storage capacity, charge and discharge power curves, and a conversion efficiency curve; and
carrying out charge and discharge tests on the actual device to obtain working characteristic data, calibrating parameters in the manual, and summarizing and organizing all technical parameters obtained from the manual and the tests as basic data for subsequent modeling.

3. The energy storage synchronous coordinated management method based on virtual synchronization technology according to claim 1, wherein S2 specifically comprises:
obtaining the rotational inertia J of the rotor from a device parameter table in kg·m², computed by the following equation:
$$J = \int {r}^{2} dm ,$$
wherein r represents a distance between a mass element and a rotating shaft, and dm represents the mass element;
the building a dynamic model of a virtual rotor comprises:
defining a state variable: selecting an angular velocity ω of the rotor as a first state sub variable, denoted as x1; selecting an angular acceleration α of the rotor as a second state sub variable, denoted as x2, wherein the state variable is represented as:
$$x = [ x 1 ; x 2 ] = [ ω ; α ] ,$$
according to the Newton's second law, a kinetic equation of the rotor is:
$$J * a = T - Bw ,$$
wherein J represents the rotational inertia of the rotor, B represents a damping coefficient, and T represents a torque;
carrying out Laplace transform according to the kinetic equation of the rotor, to obtain a state equation:
$$x 1 = \frac{( T - B * x 1 - J * x 2 )}{J} ,$$
exporting an output equation and selecting the angular velocity ω of the rotor, namely, the first state sub variable x1 as an output variable y, wherein the output equation is represented as:
$$y = C * x = [ 10 ] * [ x 1 ; x 2 ] = x 1 ,$$
organizing the above equations into a state space equation:
$$x = [ 01 ; \frac{F}{J} - \frac{1}{J} ] * x + [ 0 ; \frac{1}{J} ] * {T}_{y} = [ 10 ] * x$$
wherein
$$A = [ 01 ; - \frac{F}{J} - \frac{1}{J} ]$$
represents a state matrix,
$$F = [ 0 ; \frac{1}{J} ]$$
represents an input matrix; and C=[1 0] represents an output matrix;
carrying out model simulation on the state space equation to create two integration modules in Matlab/Simulink, integrating the state equation to obtain the first state sub variable x1 and the second state sub variable x2, then creating a gain module to compute the state matrix A and the input matrix F, finally creating an output module to compute the output matrix C and obtain the output variable y, and connecting the above modules to form a Simulink model of a state space model;
creating a standard test signal module, selecting step, direct flow, and sine as torque input signals, connecting the standard test signal module to an input end of the state space model, observing response of the first state sub variable x1 in a Scope module, namely, the angular velocity ω of the rotor, observing the shape, rising time, and resting error of a response curve; and
adjusting the damping coefficient B and the rotational inertia J of the rotor in the state matrix A, to ensure that the shape and dynamic characteristics of the response curve gradually approach to those of an actual system.

4. The energy storage synchronous coordinated management method based on virtual synchronization technology according to claim 1, wherein S3 specifically comprises:
receiving, by the adaptation layer, an output control signal of the virtual rotor, building, by the adaptation layer, a mapping relationship between speed w and reference power Pref through neural network training, and converting the output control signal into a physical energy storage recognition executable control instruction, as follows:
defining a neural network structure: setting 1 node in an input layer to represent the reference power Pref; setting 1 node in an output layer to represent the speed w; setting m nodes in a hidden layer;
assuming that a parameter from the input layer to the hidden layer is a weight matrix W1 and a parameter from the hidden layer to the output layer is a weight matrix W2, setting a neural network predicted speed w as follows:
$$w = f ( P ref ) = {W}_{2} g ( {W}_{1} Pref + b 1 ) + b 2 ,$$
wherein g represents an activation function of the hidden layer, b1 represents a bias vector of the hidden layer, b2 represents a bias vector of the output layer, f represents a mapping relationship function, Pref represents input power, W1 represents a weight matrix connecting the Pref and the hidden layer, and W2 represents a weight matrix connecting the hidden layer and the output layer;
collecting training data {Pref, w}, computing a mean square error between the network predicted speed w and an actual speed w as a loss function L, optimizing W1, W2, b1, and b2 through an error back-propagation algorithm to minimize the loss L, repeatedly training the network to gradually reduce the loss function and obtain a final mapping model, and predicting a corresponding speed w using the model f (Pref) on the new Pref; and
receiving, by the adaptation layer, a real-time speed w of the rotor
in real-time control, computing the corresponding Pref by the mapping relationship function ƒ, converting the Pref value into a control instruction of a standard communication protocol, and sending the control instruction to a control system of the energy storage device, wherein the adaptation layer is connected to the control system of the device by a reliable industrial communication link to ensure that the instruction can arrive on time; after a local controller of the device receives the instruction, activating a power control closed loop to driving components such as an inverter, to ensure that the real-time power P of the device tracks the reference value Pref.

5. The energy storage synchronous coordinated management method based on virtual synchronization technology according to claim 4, wherein S3 further comprises building constraints between the adaptation layer and the energy storage device, wherein the constraints between the adaptation layer and the energy storage device specifically comprise:
if the speed output by the virtual rotor fluctuates abnormally, the adaptation layer needs to be configured with a low-pass filter to smooth the speed signal, so as to avoid issuing a control instruction for severe fluctuations to the energy storage device;
if there is hysteresis or inertia effect inside the energy storage device, the adaptation layer needs to be added with historical states in the neural network model, to improve the adaptability to dynamic hysteresis characteristics;
if the actual power tracking performance of the device is poor, the adaptation layer needs to appropriately expand a tolerance between the control instruction and an actual power value, to avoid the impact of frequent switching on the device; and
if packet loss or delay occurs in an industrial communication network, the adaptation layer activates local predictive model compensation control when detecting a fault to ensure system stability.

6. The energy storage synchronous coordinated management method based on virtual synchronization technology according to claim 1, wherein the safety operation in S4 specifically comprises:
configuring line detection apparatuses at key nodes of the power grid, and installing current transformers to detect line current in real time on lines of the power grid; when the current exceeds a threshold, triggering an alarm; installing voltage transformers at the nodes to monitor voltage amplitude and phase in real time and determining voltage faults;
collecting voltage data of each node during normal operation of the power grid, computing a maximum value Uₘₐₓ, a minimum value Uₘᵢₙ, and an average value U_{avg} of the voltage;
determining an ultra-high voltage threshold: U_{high}=Uₘₐₓ+a %*(Uₘₐₓ−U_{avg});
determining an ultra-low voltage threshold: U_{low}=Uₘᵢₙ−3%*(U_{avg}−Uₘᵢₙ);
wherein a and β represent empirical values ranging from 0 to 100;
collecting statistics on average current I_{avg} and maximum current Iₘₐₓ of each line during normal power supply,
determining an overload alarm point: Iₒᵥₑᵣ=k1*Iₘₐₓ,
determining an overcurrent fault point: I_{fault}=k2*Iₘₐₓ,
wherein k1 represents a normal load rate of a reference line, and k2 represents 120% to 130% of rated current of the reference line;
when detecting, if the detected voltage is greater than U_{high} and lasts for more than t1 seconds, determining an ultra-high voltage fault; if the detected voltage is less than U_{low} and lasts for t2 seconds, determining an ultra-low voltage fault; if the current is greater than Iₒᵥₑᵣ and lasts for more than t3 seconds, giving an overload alarm; if the current exceeds I_{fault} and lasts for t4 seconds, determining an overcurrent fault;
wherein t1 is 2 to 3 seconds, t2 is 1 to 2 seconds, t3 is 10 to 20 seconds, and t4 is 0.5 to 1 second;
if the adaptation layer detects the ultra-high voltage fault, sending a boost charge instruction to the energy storage device to increase direct current bus voltage, sending a reactive power compensation instruction to a distribution network, and sending an excitation current decreasing instruction to an LCU of a water turbine unit to help decrease grid side voltage;
if the adaptation layer detects the ultra-low voltage fault, sending a buck discharge instruction to the energy storage device to help maintain bus voltage, sending a reactive power compensation instruction to the distribution network, and sending an excitation current increasing instruction to the LCU of the water turbine unit to help increase grid side voltage;
if the adaptation layer detects the overload fault, immediately sending a maximum discharge power instruction to the energy storage device to shunt and reduce a load, and sending a load cutting instruction to a load side to reduce overload;
if the adaptation layer detects the overcurrent fault, immediately sending a trip instruction to a circuit breaker to cut off a faulty segment, and sending an emergency stop instruction to the energy storage device to avoid affecting the device;
wherein the overload fault indicates that the device bears current or load exceeding its rated current or power in a short time, resulting in overheating or damage of the device or other safety problems, called a partial device fault; the overcurrent fault indicates a phenomenon that the instantaneous current in the circuit exceeds the designed rated current of the device or circuit;
if no faults are found in real-time monitoring, collecting all real-time data of the energy storage device and sending the data to the adaptation layer.

7. The energy storage synchronous coordinated management method based on virtual synchronization technology according to claim 1, wherein the dynamic control and predictive planning in S4 comprise determining a balance or not and sending, by the adaptation layer, a balance instruction for dynamic coordination, wherein the determining a balance or not comprises the following specific steps:
computing an average SOC value SOC_{avg} of all devices and collecting statistics on the quantity of devices currently with excessively high or low SOC;
determining whether there is SOC imbalance in the system;
checking whether a balance of power and electric quantity is established; and
setting a tolerance control deviation range;
wherein the sending, by the adaptation layer, a balance instruction for dynamic coordination comprises sending a discharge control instruction to the devices with excessively high SOC and sending a charge instruction to the devices with excessively low SOC; adjusting charge and discharge power Pi of each device using closed-loop control, and repeatedly computing and sending the control instructions at certain time intervals for dynamic coordination until the SOC of each device restores to balance.

8. The energy storage synchronous coordinated management method based on virtual synchronization technology according to claim 7,
wherein the collecting statistics on the quantity of devices currently with excessively high or low SOC comprises:
computing the average SOC value SOC_{avg} of all the devices and setting allowable up and down fluctuating ranges of SOC; if the SOC of a device is greater than the SOC_{avg} by the allowable up fluctuating range, determining that the SOC of the device is excessively high; if the SOC of a device is less than the SOC_{avg} by the allowable down fluctuating range, determining that the SOC of the device is excessively low; setting the quantity of devices with excessively high SOC as n_{high}, and setting the quantity of devices with excessively low SOC as n_{low};
wherein the determining whether there is SOC imbalance in the system comprises:
setting a tolerance percentage P_{allow} for allowed SOC imbalance, and computing an upper limit of the quantity of devices with allowed SOC imbalance as follows:
$${n}_{threshold} = {n}_{total} * {P}_{allow} ;$$
if n_{high}>n_{threshold} Or n_{low}>n_{threshold}, determining that there is SOC imbalance in the system;
wherein the checking whether a balance of power and electric quantity is established comprises:
determining capacity Ci and current SOCi, and for the device with excessively high SOC, computing its electric quantity that exceeds an average value:
$$Δ Qi = Ci \times ( SOCi - SOCavg ) ;$$
for the device with excessively low SOC, computing its electric quantity that needs to be replenished:
$$Δ Qi = Ci \times ( SOCavg - SOCi ) ;$$
summarizing a total discharge capacity ΔQ_discharge of all the devices with excessively high SOC and a total charge capacity ΔQ_charge of the devices with excessively low SOC, and mapping the ΔQi to the corresponding charge and discharge power Pi:
$$Pi = \frac{Δ Qi}{Δ t}$$
wherein Δt represents a step size; limiting the amplitude of the power Pi to not exceed the rated power of a single device;
checking whether the balance of power and electric quantity is established:
$$\sum Pi * Δ t = \sum Δ Qi ;$$
wherein the setting a tolerance control deviation range comprises:
testing response time Tᵣₑₛₚₒₙₛₑ of different models of energy storage devices executing the standard power control instruction, measuring power control precision error ε_{precision} of the devices under different SOC and temperature conditions, and setting a control cycle T_{control};
computing a response time tolerance range:
$$δ {t}_{response} = {T}_{response} - {T}_{control} ;$$
computing a precision tolerance range:
$$δ {P}_{precision} = 2 * {ε}_{precision} ;$$
comprehensively determining a total tolerance deviation range for power control:
$$Δ {P}_{tol} = δ {P}_{response} + δ {P}_{precision} ;$$
if sending a control instruction, considering a margin of ΔPₜₒₗ as follows:
P_{cmd}=P_{ideal}±ΔPₜₒₗ, wherein P_{ideal} represents target power;
if detecting feedback, keeping the actual power of the device within upper and lower limits:
P_{ideal}−ΔPₜₒₗ≤Pᵣₑₐₗ≤P_{ideal}+ΔPₜₒₗ, wherein Pᵣₑₐₗ represents real power.

9. An energy storage synchronous coordinated management system based on virtual synchronization technology, wherein the system comprises:
a device parameter collection module, configured to collect parameters of an energy storage device;
a model building module, configured to build a dynamic model of a virtual rotor according to the parameters of the energy storage device, and set rotational inertia of the rotor and torque parameters;
an adaptation layer building module, configured to build an adaptation layer to achieve interaction between the virtual rotor and the physical energy storage device;
a line detection apparatus, configured in a power grid to collect real-time data of the energy storage device, detect in real time whether a fault occurs, and carry out a safety operation when the fault occurs in the adaptation layer, or carry out dynamic control and predictive planning in the absence of faults, to solve the problem of uneven resource allocation; and
the adaptation layer, configured to determine whether the real-time data of power grid nodes and the energy storage device are normal, and if so, save logs and end, otherwise re-check and set.
